(19) United States
(12) Patent Application Publication
(10) Pub. No.: US 2021/0033473 A1
(43) Pub. Date: Feb. 4, 2021

(54) Temperature Sensor

(71) Applicant: TDK Electronics AG, Munich (DE)

(72) Inventors: Oliver Bard, Falkensee (DE); Wolfgang Grundmann, Birkenwerder (DE); Wolfgang Schatz, Berlin (DE); Abraham Kho, Singapore (SG)

(21) Appl. No.: 16/967,010

(22) PCT Filed: Jan. 17, 2019
(86) PCT No.: PCT/EP2019/051160

§ 371 Date: Aug. 3, 2020

(30) Foreign Application Priority Data
Feb. 6, 2018 (DE) 10 2018 102 600.5

(51) Int. Cl. G01K 1/18; G01K 1/12

(52) U.S. Cl. CPC G01K 1/18; G01K 1/12

(57) ABSTRACT

A temperature sensor is disclosed. In an embodiment a temperatures sensor includes a sensor element, a sheath surrounding the sensor element and a ring surrounding the sensor element, wherein the ring is covered by the sheath.

This patent application is a national phase filing under section 371 of PCT/EP2019/051160, filed Jan. 17, 2019, which claims the priority of German patent application 102018102600.5, filed Feb. 6, 2018, each of which is incorporated herein by reference in its entirety.

### TECHNICAL FIELD

The present invention relates to a temperature sensor.

### BACKGROUND

Typical temperature sensors are those that have a wired NTC resistor connected to a housing via a heat-conducting encapsulation or a thermal conductive paste. The potting material used for the encapsulation or the thermal conductive paste must be selected such that it is not electrically conductive. The potting materials available on the market have a limited thermal conductivity. Due to the limited thermal conductivity, a response time and therefore the response characteristic of the temperature sensor are also limited. The response characteristic of the temperature sensor can be determined in particular by its response time, i.e., the time that elapses before a temperature change or a resistance change is measured by the sensor.

### SUMMARY

Embodiments provide an improved temperature sensor. Further embodiments enable a response characteristic of the temperature sensor to be influenced in a desired manner.

A temperature sensor is proposed, which has a sensor element and a sheath that surrounds the sensor element, the temperature sensor also having a ring surrounding the sensor element and covered by the sheath.

The sensor element can be a wired NTC element. The sensor element can have a sensor head consisting of an NTC material and supply leads that are connected to the sensor head and via which an electrical voltage can be applied to the sensor head.

The material of the sheath can be selected such that it is not electrically conductive, in order to avoid a short circuit of the sensor element. The thermal conductivity of the sheath material affects the response speed of the temperature sensor. The sheath may have been manufactured from a potting material or a thermal conductive paste.

The ring surrounds the sensor element and is covered by the sheath. The ring may have a thermal conductivity that differs from the thermal conductivity of the sheath. This allows the thermal conductivity of the elements surrounding the sensor element—i.e., the sheath, the ring and, if applicable, a housing—to be adapted to the requirements of a system environment by a suitable choice of the material of the ring. In particular, a suitable choice of the material of the ring can be used to increase or decrease the thermal conductivity of these materials. This allows the response speed and thus the response characteristic of the temperature sensor to be adjusted by means of the ring. The design-related limitations of the response rate of the temperature sensor described above can be relaxed somewhat by the ring being arranged inside the sheath.

In addition, the ring can provide additional mechanical protection for the sensor element. In particular, the ring can mechanically protect a contact point at which the supply leads are attached to the sensor head. This means that the ring can prevent the supply leads from damage when the sensor element is installed into a housing. Damage to the supply leads could be caused, for example, by the supply leads becoming kinked or pinched during the installation. By allowing the ring to mechanically protect the supply leads, the ring can improve the electrical breakdown resistance of the temperature sensor. Supply leads that have not undergone any pinching or kinking can be subjected to higher electrical voltages.

The sensor element, the ring and the sheath can be arranged inside a housing. The housing can be in the form of a sleeve. The housing can be made of metallic material. The housing can provide mechanical protection for the sensor element. The material of the housing can have a high thermal conductivity in order to be able to rapidly transmit a change in the ambient temperature to the sensor element.

The sensor element can be connected to the housing via a sheath. The sheath and the sensor element can be arranged inside the housing. The sensor element can be attached to the housing by means of the sheath.

The ring can have a higher thermal conductivity than the sheath. Accordingly, the arrangement of the ring within the sheath can increase the response speed of the temperature sensor compared to a temperature sensor that does not have such a ring. A faster response speed can improve the measurement accuracy of the temperature sensor. In particular, a temperature sensor with a fast response can be well suited to being combined with a control unit that also has a fast response speed and therefore a short response characteristic.

The ring may comprise a ceramic material or be made of the ceramic material. Ceramic materials have a high thermal conductivity and can therefore help to enable a fast response speed of the sensor. The ceramic material can be aluminum oxide or zirconium oxide, for example.

In an alternative exemplary embodiment, the ring has a lower thermal conductivity than the sheath. This allows the elements of the sensor that surround the sensor element, i.e., the housing, the sheath and the ring, to have an overall thermal conductivity that is less than that of a temperature sensor that does not have a corresponding ring. This can slow down the response speed of the temperature sensor, as temperature changes of an ambient temperature can be transmitted less rapidly to the sensor element.

Slowing down the temperature sensor response speed is beneficial in applications where the temperature sensor is combined with a control unit that also has a slow response speed. The response speeds of the temperature sensor and the control unit should be matched to each other as closely as possible.

The material of the ring can comprise a plastic, for example, or consist of plastic. Plastic has a low thermal conductivity compared to conventional potting materials. Accordingly, the ring, which comprises or consists of plastic, can slow down the response of the temperature sensor.

The ring can be attached to the sensor element by means of the sheath. The ring and the sensor element can be, in particular, separate components. The ring can be fitted onto the sensor element when the temperature sensor is assembled. Only when the sheath is formed, for example from an encapsulation or a thermal conductive paste, is the ring finally attached to the sensor element.

Since the ring and the sensor element can be two separate components, when assembling the temperature sensor a suitable ring can be selected, the material of which adjusts the response speed of the temperature sensor in the desired way. It is possible to design two temperature sensors using the same housing, an identical sheath and identical sensor elements, which differ from one another only in the material of the rings. Two such temperature sensors have different response characteristics. Accordingly, different temperature sensors can be produced in such a way that a large number of production steps are identical. In this way, the temperature sensors can be produced in a very efficient way.

The ring can partially cover a supply lead of the sensor element. In particular, the ring can cover a contact point of the sensor element with the supply lead. The sensor element can be a wired NTC resistor. The sensor element may have thin long wires as supply leads, which means that there is a risk of damaging these supply leads during the manufacturing process. The ring can also protect the supply leads from mechanical damage, for example due to kinks or pinching.

The sheath can be made of a thermal conductive paste. Alternatively, the sheath can have a thermally conductive encapsulation.

The temperature sensor can be a temperature gauge for use in small appliances in the domestic, automotive or heating engineering sectors.

Various other embodiments relate to an arrangement which has a temperature sensor, and a control unit which is connected to the temperature sensor. The temperature sensor can be, in particular, the temperature sensor described above.

For example, the control unit can control a control loop. The temperature determined by the temperature sensor can be considered as the input variable of the control unit. In particular, the control unit can send out control signals that depend on the temperature determined by the temperature sensor.

If the control unit modifies a variable of the control loop, this can cause a temperature to change. This temperature change can be detected by the temperature sensor again and transmitted to the control unit. In this way, the control unit can be designed to permanently regulate and adjust a temperature in a desired manner. For optimum cooperation between the temperature sensor and the control unit, it is necessary for the temperature sensor and the control unit to have as identical a response characteristic as possible. Therefore, the response characteristic of the temperature sensor can be matched to the response characteristic of the control unit. A matching of the response characteristic of the temperature sensor can be achieved, in particular, by a suitable choice of the material of the ring.

### BRIEF DESCRIPTION OF THE DRAWINGS

In the following, a preferred exemplary embodiment of the present invention is described based on the figures:

FIG. 1 shows a cross section through a temperature sensor; and

FIG. 2 shows a temperature sensor in a perspective view.

### DETAILED DESCRIPTION OF ILLUSTRATIVE EMBODIMENTS

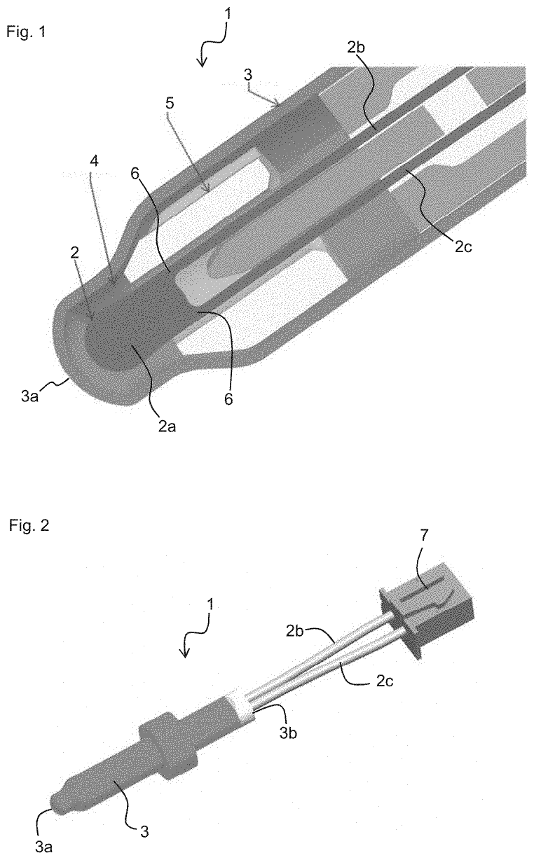

FIG. 1 shows a cross section through a temperature sensor 1. The temperature sensor 1 comprises a sensor element 2. The sensor element 2 is an NTC element. In particular, it is a wired NTC element. The sensor element 2 has a sensor head 2a, which is made of an NTC material, and supply leads 2b, 2c. The supply leads 2b, 2c are thin long wires. The sensor head 2a is connected to two supply leads 2b, 2c, via which an electrical voltage can be applied to the sensor head 2a.

The sensor element 2 is arranged in a housing 3. The housing 3 is in the form of a sleeve. The housing 3 comprises a metallic material. The metallic material of the housing 3 has a high thermal conductivity and is therefore well suited for use in a temperature sensor 1. However, the material of the housing 3 also has an electrical conductivity, so that contact between the sensor element 2 and the housing 3 must be prevented in order to ensure a high electrical breakdown strength of the sensor element 2 and to prevent a short circuit.

The housing 3 has a front end 3a and a tail end 3b located opposite to the front end 3a. The housing 3 is closed at its front end 3a. The sensor head 2a is arranged inside the housing 3 and near the front end 3a of the housing 3. The supply leads 2b, 2c extend out of the tail end 3b of the housing.

The temperature sensor 1 also comprises a sheath 4, which surrounds the sensor element 2. The sheath 4 is arranged inside the housing 3. In particular, the sheath 4 surrounds the sensor head 2a and a part of the supply leads 2b, 2c which is attached directly to the sensor head 2a. A rear part of the supply leads 2b, 2c facing away from the sensor head 2a is not surrounded by the sheath 4.

The sheath 4 can be a potting compound or a thermal conductive paste.

The sensor element 2 and the sheath 4 are arranged inside the housing 3. The sensor element 2 is connected to the housing 3 via the sheath 4 and fixed inside the housing 3. The material of the sheath 4 is not electrically conductive, in order to avoid short-circuiting the sensor element 2. The material of the sheath 4 should have a high thermal conductivity in order to be able to pass temperature changes readily on to the sensor element 2.

In addition, the temperature sensor 1 has a ring 5 that encloses the sensor element 2. In particular, the ring 5 encloses contact points 6 at which the supply leads 2b and 2c are attached to the sensor head 2a. The ring 5 partially overlaps with the sensor head 2a.

The material of the ring 5 influences the thermal conductivity of the temperature sensor 1. The response speed of the temperature sensor 1 is directly dependent on the thermal conductivity of the temperature sensor 1. If the housing 3, the sheath 4 and the ring 5 have a high overall thermal conductivity, temperature changes can be passed on to the sensor element 2 very quickly, which results in a short response time of the temperature sensor 1. “Overall thermal conductivity” in this context refers to the resulting thermal conductivity for the unit consisting of the housing 3, the sheath 4 and the ring 5, wherein the overall thermal conductivity is determined by the thermal conductivities and the material quantities of the housing 3, the sheath 4 and the ring 5.

If, on the other hand, the unit formed by the housing 3, the sheath 4 and the ring 5 has a low overall thermal conductivity, this results in a slow response speed of the temperature sensor 1, as temperature changes cannot be quickly passed on to the sensor element 2. By suitable choice of the material of the ring, it is thus possible to adjust the response speed of the temperature sensor 1 in a desired manner.

For example, the ring 5 may consist of a ceramic material, the thermal conductivity of which is greater than the thermal conductivity of the sheath 4. This can increase the response speed of the temperature sensor 1 compared to a temperature sensor that does not have such a ring. The coefficient of thermal conductivity of the ceramic material can be in a range between 3 W/mK to 40 W/mK, for example. The ceramic material can be aluminum oxide, zirconium oxide or other ceramic materials, for example.

Alternatively, the ring 5 may consist of a material, the thermal conductivity of which is lower than the thermal conductivity of the sheath 4. This can slow down the response speed of the temperature sensor 1 compared to a temperature sensor that does not have such a ring 5. The material of the ring 5 can comprise a plastic, for example. The coefficient of thermal conductivity of the material of the ring 5 can be, for example, between 0.15 W/mK and 0.5 W/mK.

In addition to the adjustment of the response speed of the temperature sensor 1 in a desired manner, the ring 5 can also improve the voltage breakdown strength of the temperature sensor 1. When the sensor element 2 is being installed in the sheath 4 there is a risk that the sensor element 2 will be damaged. In particular, the supply leads 2b, 2c can become pinched or kinked if the sensor element 2 is inserted too deeply into the sleeve-shaped housing 3, which is filled with the material for the sheath 4. This may restrict the loading capacity of the supply leads 2b, 2c when a high voltage is applied. If the supply leads 2b, 2c are kinked or pinched during assembly such that they come into contact with an inner side of the housing 3, a short circuit may occur.

To prevent mechanical damage to the supply leads 2b, 2c during installing of the sensor element 2 in the housing 3, the ring 5 can be fitted onto the sensor element 2 before the sensor element 2 is installed in the housing. In particular, the ring 5 covers the contact points 6 of the supply leads 2b, 2c with the sensor head 2a. Accordingly, the ring 5 protects a mechanical weak point of the sensor element 2. The ring can prevent the supply leads 2b, 2c from becoming kinked or pinched when the sensor element 2 is installed in the housing 3, which is filled with the material of the sheath 4. This means the ring 5 can ensure that the sensor element 2 can be subjected to a high voltage, thus improving the electrical breakdown strength of the temperature sensor 1.

In the following text, the manufacturing method of the temperature sensor 1 is described:

The sheath 4 can be poured into the housing 3 as a material in liquid or paste form. Then the sensor element 2, on which the ring 5 has already been fitted, is inserted into the housing 3. The ring 5 is held on the sensor element 2 by friction forces.

The ring 5 is not irreversibly fixed to the sensor element 2 at this point.

The sensor element 2 is inserted far enough into the housing 3 that at least the sensor head 2a and the ring 5 are completely covered by the material of the sheath 4. Then the material of the sheath 4 is cured.

FIG. 2 shows the temperature sensor 1 in a perspective view. The temperature sensor 1 is a temperature measuring gauge. On an end of the supply leads 2b, 2c facing away from the sensor head 2a, a connector 7 is arranged, via which the temperature sensor 1 can be connected to a control unit, for example. The temperature sensor 1 can be used in small domestic appliances, in the automotive sector or in heating engineering.

By using the ring 5 that surrounds the sensor element 2, as described above, the response speed of the temperature sensor 1 can be adjusted as desired. In particular, the response speed can be set such that it matches the response speed of the control unit. The control unit can be the controller of a control loop.

1-15. (canceled)

16. A temperature sensor comprising:
a sensor element;
a sheath surrounding the sensor element; and
a ring surrounding the sensor element,
wherein the ring is covered by the sheath.

17. The temperature sensor according to claim 16, further comprising a housing, wherein the sensor element, the ring and the sheath are arranged inside the housing.

18. The temperature sensor according to claim 16, wherein the ring has a higher thermal conductivity than the sheath.

19. The temperature sensor according to claim 16, wherein the ring comprises a ceramic material.

20. The temperature sensor according to claim 16, wherein the ring has a lower thermal conductivity than the sheath.

21. The temperature sensor according to claim 16, wherein a material of the ring comprises a plastic.

22. The temperature sensor according to claim 16, wherein the ring is fixed to the sensor element the sheath.

23. The temperature sensor according to claim 16, wherein the ring and the sensor element are separate components.

24. The temperature sensor according to claim 16, wherein the ring is fitted onto the sensor element.

25. The temperature sensor according to claim 16, wherein the ring partially covers a supply lead of the sensor element.

26. The temperature sensor according to claim 16, wherein the sensor element has a sensor head consisting essentially of an NTC material, and wherein the ring covers a contact point between the sensor head and the supply lead.

27. The temperature sensor according to claim 16, wherein the sheath comprises a thermal conductive paste, or wherein the sheath has a thermally conductive encapsulation.

28. The temperature sensor according to claim 16, wherein the temperature sensor is a temperature gauge configured to be uses in small appliances in the domestic, automotive or heating engineering sectors.

29. An assembly comprising:
the temperature sensor according to claim 16; and
a controller connected to the temperature sensor.

30. The assembly according to the claim 29, wherein a response of the temperature sensor is matched to the response of the controller.

31. The assembly according to claim 29, wherein a response of the temperature sensor is matched to the response of the controller by a suitable choice of a material of the ring.
